(19) United States
(12) Patent Application Publication
(10) Pub. No.: US 2021/0201306 A1
(43) Pub. Date: Jul. 1, 2021

(54) INFORMATION PROCESSING APPARATUS AND METHOD

(71) Applicant: FeliCa Networks, Inc., Tokyo (JP)

(72) Inventors: Junji GOTO, Chiba (JP); Takayuki HIRANO, Chiba (JP); Minako TAKAHASHI, Tokyo (JP); Yukari KOYAMA, Kanagawa (JP); Tatsufumi TANABE, Kanagawa (JP)

(73) Assignee: FeliCa Networks, Inc., Tokyo (JP)

(21) Appl. No.: 17/057,856

(22) PCT Filed: May 24, 2019
(86) PCT No.: PCT/JP2019/020604

§ 371 Date: Nov. 23, 2020

(30) Foreign Application Priority Data
Jun. 8, 2018 (JP) 2018-110052

(51) Int. Cl. G06Q 20/38; G06Q 20/34

(52) U.S. Cl. CPC G06Q 20/3821; G06Q 20/3572

(57) ABSTRACT

There is provided an information processing apparatus and method for achieving easily reducing the risk of unauthorized use. The information processing apparatus includes: a management unit configured to retrieve service use information that is used for using a service and recorded on a recording medium in association with card identification information regarding other account information different from predetermined account information, the card identification information identifying a card for using the service; and a communication unit configured to upload the service use information obtained through the retrieval. The present technology is applicable to service providing systems.

### TECHNICAL FIELD

The present technology elates to an information processing apparatus and a method, in particular, to an information processing apparatus and a method for achieving easily reducing the risk of unauthorized use.

### BACKGROUND ART

In recent years, various services utilizing, mobile terminals such as electronic money payment using mobile terminals functioning as virtual cards have been provided.

Further, for example, as a technology for preventing data on a mobile terminal from being unauthorizedly used, a technology for securely transferring data from an old mobile terminal, which has been used, to a new mobile terminal has been proposed (for example, see PTL 1).

In this technology, a key for accessing data is appropriately changed between an old mobile terminal and a new mobile terminal so that the data on the old mobile terminal can be prevented from being unauthorizedly used.

### CITATION LIST

### Patent Literature

### [PTL 1]

Japanese Patent Laid-open No. 2003-141429

### SUMMARY

### Technical Problems

In the technology described above, however, in a case where information regarding a plurality of users is recorded on one mobile terminal, the risk of unauthorized use of these pieces of information cannot easily be reduced.

For example, there are a case where a user hands over a mobile terminal on which electronic money remains to another user, and a case where a plurality of users shares one mobile terminal.

In such cases, if a user hands over a mobile terminal to another user before using up his/her own electronic money on the mobile terminal, there is a risk that the other user may unauthorizedly use the electronic money, which is troublesome.

The present technology has been made in view of such circumstances, and achieves easily reducing the risk of unauthorized use.

### Solution to Problems

According to a first aspect of the present technology, there is provided an information processing apparatus including: a management unit configured to retrieve service use information that is used for using a service and recorded on a recording medium in association with card identification information regarding other account information different from predetermined account information, the card identification information identifying a card for using the service; and a communication unit configured to upload the service use information obtained through the retrieval.

According to the first aspect of the present technology, there is provided an information processing method including the steps of: retrieving service use information that is used for using a service and recorded on a recording medium in association with card identification information regarding other account information different from predetermined account information, the card identification information identifying card for using the service; and uploading the service use information obtained through the retrieval.

In the first aspect of the present technology, service use information that is used for using a service and recorded on a recording medium in association with card identification information regarding other account information different from predetermined account information is retrieved, the card identification information identifying a card for using the service, and the service use information obtained through the retrieval is uploaded.

According to a second aspect of the present technology, there is provided an information processing apparatus including: a recording unit configured to record account information identifying a user, terminal information identifying a terminal apparatus configured to function as a card for using a service, and card identification information identifying the card in association with each other; a control unit configured to retrieve, in case of receiving the account information and the terminal information from the terminal apparatus, the card identification information recorded on the recording unit in association with other account information different from the account information received and the terminal information received; and a communication unit configured to transmit the card identification information obtained through the retrieval to the terminal apparatus.

According to the second aspect of the present technology, there is provided an information processing met nod including causing an information processing apparatus including a recording unit configured to record account information identifying a user, terminal information identifying a terminal apparatus configured to function as a card for using a service, and card identification information identifying the card in association with each other to perform the steps of retrieving, in case of receiving the account information and the terminal information from the terminal apparatus, the card identification information recorded on the recording unit in association with other account information different from the account information received and the terminal information received; and transmitting the card identification information obtained through the retrieval to the terminal apparatus.

In the second aspect of the present technology, in an information processing apparatus including a recording unit configured to record account information identifying a user, terminal information identifying a terminal apparatus configured to function as a card for using a service, and card identification information identifying the card in association with each other, in a case where the account information and the terminal information are received from the terminal apparatus, the card identification information recorded on the recording unit in association with other account information different from the account information received and the terminal information received are retrieved, and the card identification information obtained through the retrieval is transmitted to the terminal apparatus.

### Advantageous Effects of Invention

According to the first and second aspects of the present technology, the risk of unauthorized use can be easily reduced.

Note that, the effects described here are not necessarily limited, and may be any effect described in the present disclosure.

### BRIEF DESCRIPTION OF DRAWINGS

FIG. 1 is a diagram illustrating the management virtual cards.

FIG. 2 is a diagram illustrating the upload of information regarding virtual cards.

FIG. 3 is a diagram illustrating a d splay screen transition example.

FIG. 4 is a diagram illustrating a configuration example of a client.

FIG. 5 is a diagram illustrating a configuration example of a server.

FIG. 6 is a diagram illustrating examples of information that is managed in the server.

FIG. 7 is a flowchart illustrating launch processing and retrieval processing.

FIG. 8 is a diagram illustrating a configuration example of a computer.

### DESCRIPTION OF EMBODIMENT

Now, with reference to the drawings, an embodiment to which the present technology is applied is described.

### FIRST EMBODIMENT

### <Present Technology>

In the present technology, in a case where a predetermined user is to receive a service using a client, when service use information regarding other users is recorded on the client, the service use information is uploaded to a server so that the risk of unauthorized use can be easily reduced.

Examples of the service used herein may include any service such as services using clients functioning as virtual cards for payment or the like and services for managing various pieces of information regarding users, such as images, medication histories, or purchase histories. Further, the service use information is information that is used when users use services. Examples of the service use information include electronic money balance information, images, medication history information, or purchase history information to be managed, and the like.

In the following, as a specific example, a case where a user operates a client to function as virtual cards to use services such as payment is described.

In this case, the virtual cards are, for example, cards for electronic money payment or the like, cash cards, credit cards, debit cards, prepaid cards, point cards, other payment cards, or the like.

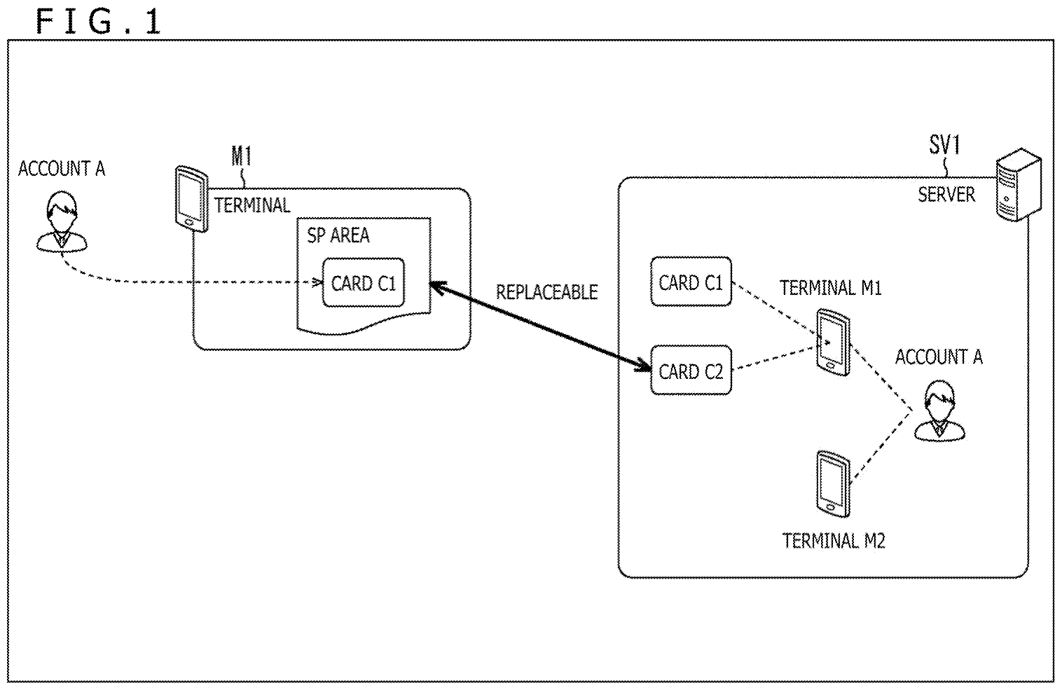

It is assumed, for example, that, as illustrated in FIG. 1, service providing system configured to provide services to users has a terminal M1 that is a client and a server SV1.

In this example, the terminal M1 is a device that user who uses the services owns. Examples of the terminal M1 include terminal apparatuses such smartphones, tablets, and personal computers.

Further, here, the user owning the terminal M1 is a user identified account information “ACCOUNT A.” The user identified by the account informal ion “ACCOUNT” is hereinafter also referred to as “user A,” in particular.

Moreover, it is assumed that virtual cards C1 and C2 have been issued for the user A. Note that, the card. C1 and the card C2 may be used when the user receives different services or the same service.

In particular, in the example illustrated in FIG. 1, information regarding the card C1 is recorded in an SP (Service Provider) area provided in the terminal M1. The user A can operate the terminal M1 to function as the virtual card C1 and use a service using the card C1. Note that, the SP area is a recording area provided for each service, that is, each service provider that provides a service.

Meanwhile, in the server SVS, account information identifying users, terminal information identifying terminals that are clients, and information regarding virtual cards that are used for using services are managed in association with each other.

Here, terminal information indicating the terminal M1 that the user A owns and terminal information indicating a terminal M2 that the user A owns are recorded on the server SV1 in association with the user A account information “ACCOUNT A.”

Further, on the server SV1, information regarding the virtual card C1 and information regarding the virtual card C2 are recorded in association with the terminal information indicating the terminal M1. Here, the information regarding the virtual cards can be card identification information identifying cards, electronic money balance information, or the like.

In the server SV1, the account information, the terminal information, and the information regarding, virtual cards are managed in association with each other in this way so that card operation on the terminal, which is a client, such as replacing or deleting a virtual card can be performed with the agreement of the user.

Specifically, the state illustrated in FIG. 1, for example, the terminal M1 has recorded thereon the information regarding the card C1 so that the terminal MI can function as the card C1. From such a State, for example, the information regarding the card C1 is replaced (overwritten) by the information regarding the card C2 so that the user A can operate the terminal M1 to function as the card C2.

Further, in this example, in the server SV1, one account information can be managed in association with the plurality of pieces of terminal information, and hence the user can use the plurality of terminals.

Incidentally, at the moment, with regard to the terminal M1 that the user A owns, a case where the user A shares the terminal M1 with other users, and a case where the user A has got the terminal M1 from another user or the like are conceivable.

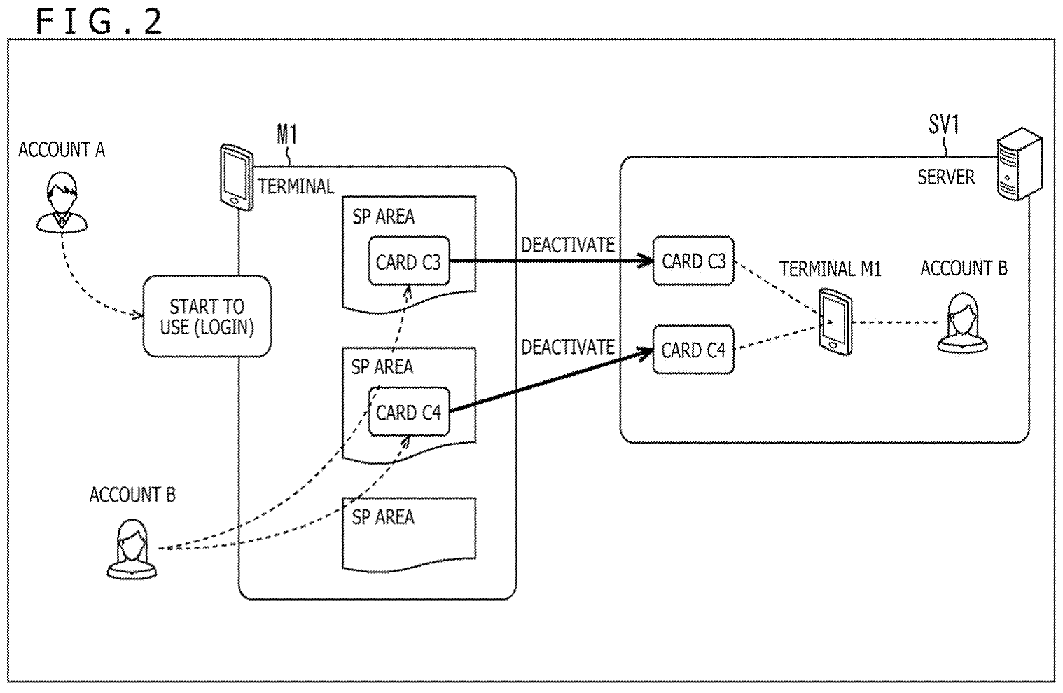

In such cases, as illustrated in FIG. 2, for example, the terminal M1 may have recorded thereon information regarding virtual cards that other users have. Note that, in FIG. 2, portions corresponding to those in the case of FIG. 1 are denoted by the same reference symbols, and descriptions thereof are appropriately omitted.

In the example illustrated FIG. 2, on the server SV1, account information regarding a user B “ACCOUNT b,” and information regarding a virtual card C3 and information regarding' a virtual card C4 that have been issued for the user B are recorded in association with the terminal information indicating the terminal M1.

That is the user B used to use the terminal M1 by operating the terminal M1 to function as the card C3 or the card C4 in the past or the user B can currently use the terminal M1 by operating the terminal M1 to function as the card C3 or the card C4.

Further, also on the terminal M1, the information regarding the card C3 is recorded in one SP area, while the information regarding' the card C4 is recorded in another SP area.

For example, when electronic money balance information or the like is recorded as the information regarding the card C3 or the card C4, there is a risk that the user A having the terminal M1 uses the card C3 or the card C4 of the user B without permission.

Accordingly, in the present technology, when the user A logs in with the terminal M1, that is, when the user A starts to use a system (service) provided by the server SV1, it is immediately retrieved whether the terminal M1 has recorded thereon information regarding virtual cards of other users different from the user A.

Then, in a case where, information regarding virtual cards of other users has been obtained as a result of the retrieval, the information regarding the virtual cards is uploaded to the server SV1 right away. In other words, the information regarding the virtual cards of other users in the terminal M1 is automatically saved (transmitted) to the server SV1, and the virtual cards are thus deactivated.

In the example of FIG. 2, when the user A logs in with the terminal M1, in the terminal M1, it is retrieved whether or not there is information regarding virtual cards in association with account information different from the user A account information “ACCOUNT A.”

Here, the information regarding the card C3 and the information regarding the card C4 of the user B are obtained as the retrieval result. Thus, the information regarding the card C3 and the information regarding the card C4 are uploaded to the server SUI, and the card C3 and the card C4 are thus deactivated.

When the card C3 and the card C4 are deactivated in this way, no service can be used with the terminal M1 functioning as the virtual card C3 or the card C4 so that the unauthorized use of the card C3 and the card C4 can be prevented.

In particular, when the information regarding the card C3 and the information regarding the card C4 are uploaded to the server SV1, in the terminal M1, the information regarding the card C3 and the information regarding the card C4 are deleted so that the unauthorized use can be prevented. That is, the security can be enhanced.

As specific use case, it is assumed, for example, that the user B hands over, to the user A, the terminal MI on which the electronic money of his/her own card C3 and card C4 remains.

Then, when the user A logs to a service using the terminal M1 thereafter, the remaining electronic money or the like of the card C3 and the card C4 is automatically uploaded to the server SV1. Thus, a risk that the user A or other users use the electronic money of the user B can be reduced.

Further, the user B can log in with the terminal M1 or another terminal again and download the information regarding his/her own card C3 and card C4 from the server SV1, to thereby continue to use his/her own remaining electronic money.

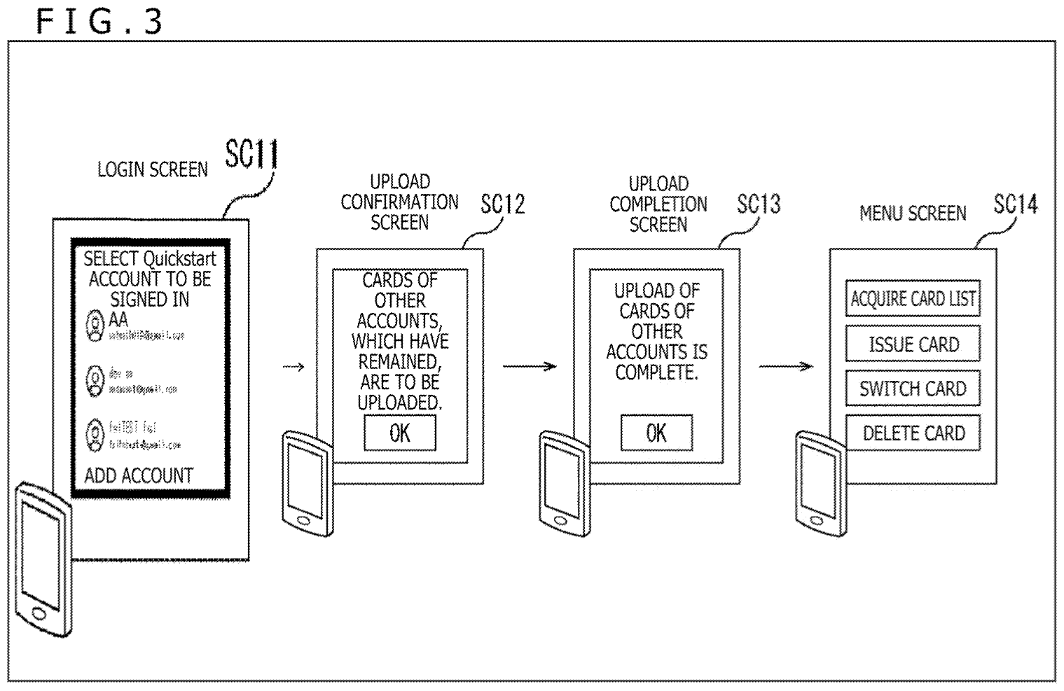

In this way, in the present technology, when the user logs in with the terminal (client), information regarding virtual cards of other users is automatically uploaded to the server. In such a case, an upload confirmation screen and the like illustrated in FIG. 3, for example, may be displayed on the terminal.

In the example of FIG. 3 first, the user operates his/her own terminal to display a login screen SC11 as illustrated on the left of FIG. 3. On the login screen SC11, a list of account information recorded on the memory of the terminal is displayed, and the user selects his/her own account information from these pieces of account information and inputs a password or the like as necessary.

When the user has logged in, as described above, information regarding virtual cards of other users is then retrieved. In a case where there is information regarding cards of other users as a result of the retrieval, an upload confirmation screen SC12 displayed on the terminal.

On the upload confirmation screen SC12, a message indicating that information regarding cards of other users, that is, other accounts is to be uploaded “CARDS OF OTHER ACCOUNTS, WHICH HAVE REMAINED, ARE TO BE UPLOADED.” and a confirmation button having the term “OK” are displayed.

When the user confirms the message and presses the confirmation button, the information regarding the cards of other users is uploaded to the server When the upload is complete, an upload completion screen SC13 is displayed on the terminal.

On the upload completion screen SC13, a message indicating that the upload is complete “UPLOAD OF CARDS OF OTHER ACCOUNTS IS COMPLETE.” and a confirmation button having the term “OK” are displayed.

When the user confirms the message and presses the confirmation button, the display screen of the terminal transitions to a menu screen SC14.

On the menu screen SC14, buttons that the logged-in user uses to perform operation for available services are displayed. The user operates a desired button to receive a service or the like.

Here, for example, by pressing the button having the message “ACQUIRE CARD LIST,” the user can make the terminal display list of virtual cards that he/she owns. Moreover, the user can select any card from the card list to use a service such as payment or the like using the selected card.

Further, for example, by pressing the button having the message “ISSUE CARD,” the user can apply for a new virtual card for him or her. By pressing the button having the message “SWITCH CARD,” the user can switch a virtual card that he/she is to use on the terminal to another card. Moreover, by pressing the button having the message “DELETE CARD,” the user can delete his/her own virtual card, that is, invalidate the virtual card.

### <Configuration Example of Client>

Next, specific configuration examples of client and server to which the present technology is applied are described.

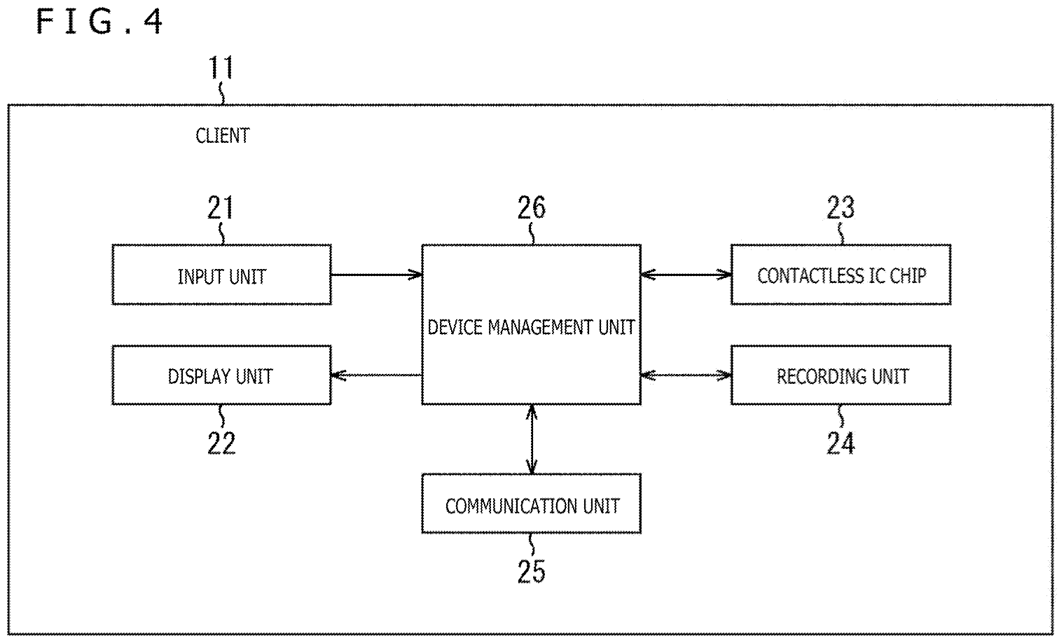

FIG. 4 is a diagram illustrating a functional configuration example of a client to which the present technology is applied.

A client 11 illustrated in FIG. 4 is an information processing apparatus including a terminal apparatus such as a smartphone, tablet, or personal computer that, for example, a user who uses services owns, and corresponds to the terminal M1 illustrated in FIG. 2, for example. The client 11 itself can function as virtual cards. Note that, here, the example in which the client 11 is a terminal apparatus is described, but the client 11 may be an IC (Integrated Circuit) card.

The client 11 includes an input unit 21 a display unit 22, a contactless IC (Integrated Circuit) chip a recording unit 24, a communication unit 25, and a device management unit 26.

The input unit 21 includes, for example a touch panel provided on the display unit 22 in an overlapping manner, buttons, or switches, and supplies signals based on operation by the user to the device management unit 26. The display unit 22 includes, for example, a liquid crystal display panel, and displays various images on the basis of image data supplied from the device management unit 26.

The contactless IC chip 23 is a recording medium capable of contactlessly communicating with readers/write=s. The contactless IC chip 23 has recorded thereon information regarding' the services that the user uses or the like, and appropriately supplies recorded information to the device management unit 26.

Specifically, the contactless IC chip 23 has recorded thereon an ID unique to the contactless IC chip 23 itself as terminal information identifying the contactless IC chip 23.

In particular, in this example, the contactless IC chip 23 is incorporated in and fixed to the client 11, and hence the terminal information recorded on the contactless IC chip 23 is used as information uniquely identifying the client 11. Note that, the contactless IC chip 23 may be removably mounted on the client 11, or a non-volatile memory without the contactless communication function may be used instead of the contactless IC clip 23.

Further, the contactless IC chip 23 has SP areas for respective service providers, for example. In the SP areas, card identification information identifying virtual cards that the user has is also recorded.

Moreover, in an SP area, service use information that is used when a service is used with a virtual card identified by card identification information is recorded in association with the card identification information in some cases.

Here, the service use information is, for example, value information that is used for payment or the like using a service. More specifically, for example, the value information is information regarding the remaining points (the number of points) of a point card, information regarding the balance or limit of a cash card or the like, the credit card number of a credit card, or information regarding the balance (remaining amount) of electronic money of a prepaid card or other payment cards. Note that, the service use information is not limited to the value information and may be any type of information as long as being information that is used for using services.

For example, in the case of a service for managing medication histories or purchase histories using virtual cards, information regarding the medication history or purchase history of the user may be service use information or like.

Besides, here, the example in which the user uses services with virtual cards is described. In a case where a service for managing the images of users in association with image IDs identifying the images is provided, however, the images of the users can be service use information.

In this case, for example, in an SP area, an image is recorded in association with an image ID instead of card identification information. The card identification information and the image ID are identification information identifying a user-specific matter that is used for using a service, such as a virtual card or an image to be managed.

Thus, it can be said that, in an SP area, service use information can be appropriately recorded in association with identification information identifying a user-specific matter that is used for using a service. In particular, in the embodiment, a specific example of the identification information is the card identification information.

As described above, on the contactless IC chip 23, at least terminal information and card identification information are recorded, and service use information is recorded in association with the card identification information in some cases.

The recording unit 24 includes a non-volatile memory or the like, and records various pieces of information such as user account information, application programs, and the like. The recording unit 24 records information or the like supplied from the device management unit 26 or supplies recorded information or the like to the device management unit 26.

The communication unit 25 communicates with an external apparatus such as the server with a cable or wirelessly. The communication unit 25 supplies received information to the device management unit 26 or transmits information supplied from the device management unit 26.

The device management unit 26 controls the entire operation of the client 11. For example, the device management unit 26 retrieves, in response to a signal supplied from the input unit 21, service use information associated with card identification information regarding other users from the contactless IC chip 23, or supplies service use information obtained as a retrieval result to the communication unit 25 so that the communication unit 25 uploads the service use information.

### <Configuration Example of Server>

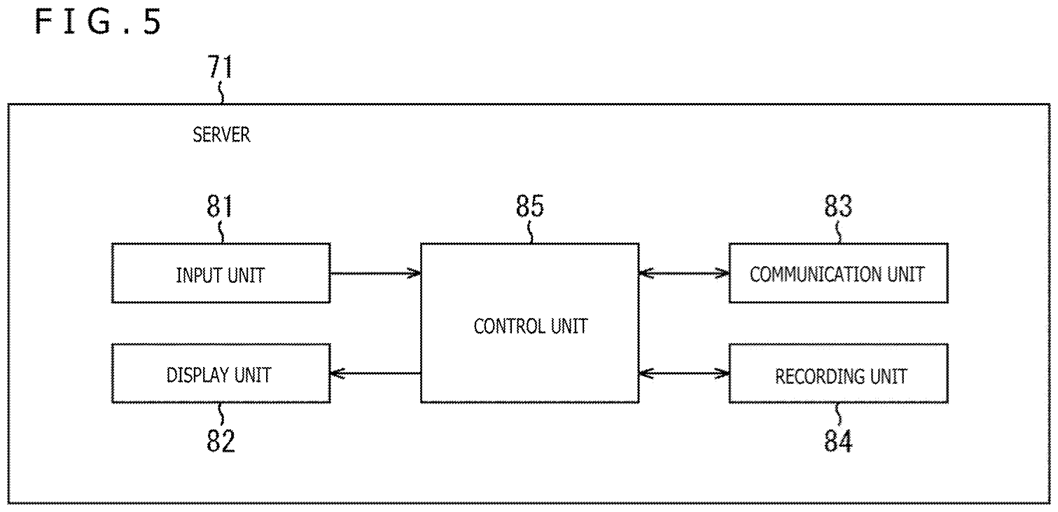

FIG. 5 is a diagram illustrating a functional configuration example of a server to which the present technology is applied.

A server 71 illustrated in FIG. 5 is an information processing apparatus configured to manage matters related to service provision, such as the use of virtual cards by users, and corresponds to the server SV1 illustrated in FIG. 2, for example.

The server 71 includes an input unit 81, a display unit 82, a communication unit 83, a recording unit 84, and a control unit $5.

The input unit 81 includes, for example, a mouse or a Keyboard, and supplies, to the control unit 85, signals based on operation by the administrator or the like of the server 71. The display unit 82 includes, for example, a liquid crystal display panel, and displays various images on the basis of image data supplied from the control unit 85.

The communication unit 83 communicates with an external apparatus such as the client 11 with a cable or wirelessly. The communication unit 83 supplies received information to the control unit 85 or transmits information supplied from the control unit 85.

The recording unit 84 includes a non-volatile memory or the like, and records various pieces of information such as account information and terminal information, programs, and the like. The recording unit 84 records information or the like supplied from the control unit 85 or supplies recorded information or the like to the control unit 85.

The control unit 85 controls the entire operation of the server 71. For example, the control unit 85 retrieves card identification information regarding, a predetermined user from the recording unit 84, or supplies card identification information obtained through retrieval to the communication unit 83 so that the communication unit 83 transmits the card identification information.

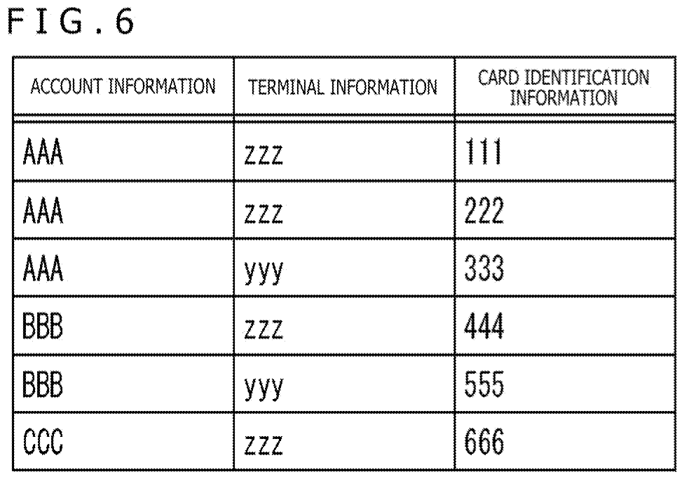

Incidentally, in the recording unit 84, as illustrated in FIG. 6. for example, account information terminal information, and card identification information regarding cards of respective users are managed in association with each other.

That is, in this example, account information, terminal information, and card identification information are recorded in association with each other. For example, terminal information “zzz” and account information “AAA” are recorded in association with card identification information “111.”

From the above, it is found that a user indicated by the account information “AAA” can operate the client 11 indicated by the terminal information “zzz” to function as a virtual card identified by the card identification information “111” to use services.

In particular, in the server 71, not only terminal information but also account information is managed in association with card identification information, and hence the correspondence between cards and users can thus be grasped. Further, whether there is a possibility that one client 11 has service use information regarding a plurality of users can be specified.

Moreover, although not illustrated in FIG. 6, in the recording unit 84, in association with card identification information, card status management information for managing the status of a card identified by the card identification information is also recorded.

Here, the card status management information includes, for example, information indicating whether a card is active or inactive, t at whether the client 11 is usable as the card or not, service use information, the use history of the card, or the like.

### <Descriptions of Launch Processing and Retrieval Processing>.

Subsequently, how the client 11 and the server 71 operate is described.

For example, in a case where a user operates the client 11 to function as a virtual card to use a service, first, the user operates the input unit 21 of the client 11 to issue an instruction on launching an application program for using the service.

Then, the client 11 launches the application program in response to the user operation, and starts, as necessary, launch processing of uploading service use information. Further, when the launch processing starts, in response to this, in the server 71, retrieval processing of retrieving card identification information regarding cards to be uploaded starts.

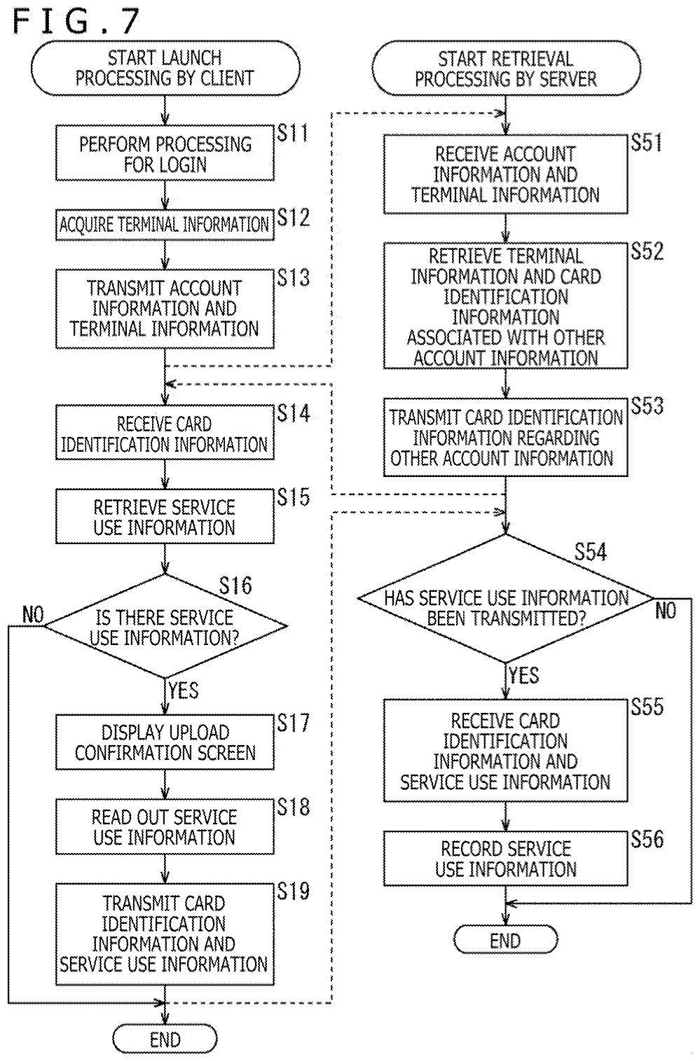

Now, with reference to the flowchart of FIG. 7. the launch processing by the client 11 and the retrieval processing by the server 71 are described.

When the client 11 starts the launch processing, in Step 511, the device management unit 26 launches an application program and performs processing for login.

Specifically, for example, the device management Quit 26 reads out all account information recorded on the recording unit 24 to generate image data for displaying a login screen, and supplies the image data to the display unit 22 so that the display unit 22 displays the login screen. With this, the login screen. SC11 illustrated in. FIG. 3, for example, is displayed.

When the login screen is displayed, the user operates the input unit 21 to select his/her own account information on the login screen and input a password as necessary. Then, the device management unit 26 authenticates the user as necessary, and the login of the user is complete with the selected account information.

In step S12, the device management unit 26 reads out terminal information from the contactless IC chip 23 to acquire the terminal information uniquely identifying the client 11.

Further, the device management unit 26 supplies, to the communication unit 25, the acquired terminal information and the user account information specified at the login, and instructs the communication unit 25 to transmit the terminal information and the account information to the server 71.

In Step S13, the communication unit 25 transmits, to the server 71, the account information and terminal information supplied from the device management unit 26.

Then, in the server 71, in Step S51, the communication unit 83 receives the account information and terminal information transmitted from the client 11, and supplies the account information and the terminal information to the control unit 85.

In Step S52, the control unit 85 retrieves, from the recording' unit 84, card identification information associated with the terminal information received in Step S51 and other account information different from the account information received in Step S51.

Then, the control unit 85 supplies the card identification information obtained as a result of the retrieval to the communication unit 83, and instructs the communication unit 83 to transmit the card identification information to the client 11.

Specifically, it is assumed, for example, that the recording unit 84 has recorded thereon the account information, terminal information, and card identification information illustrated in FIG. 6, and in Step S51, the account information “AAA” and the terminal information “zzz” are received.

In this case, the control unit 85 retrieves, from the card identification information recorded on the recording unit 84, card identification information associated with account information different from the account information “AAA” and the terminal information “zzz.”

In this example, as a result of the retrieval, card identification information “444” associated with account information “BBB” and the terminal information “zzz,” and card identification information “666” associated with account information “CCC” and the terminal information “zzz” are obtained.

The thus obtained card identification information “444” and “666” is information identifying cards of other users different from the logged-in user identified by the account information “AAA.”

Further, the cards identified by the card identification information “444” and “666” are used in the client 11 identified by the terminal information “zzz” that is used with the logged in account information “AAA.”

Thus, if the client 11 identified by the terminal information “zzz” has recorded thereon service use information regarding the cards identified by the card identification information “444” or “666,” there is a risk that the service use information is unauthorizedly used.

Accordingly, to specify whether the client 11 has recorded thereon such service use information or not, the client 11 notifies the client 11 of the card identification information “444” and “666” (transmits the card identification information “444” and “666”) to instruct the client 11 to retrieve service use information that needs to be uploaded.

In this way, in case of receiving, from the client 11, account information and terminal information, the control unit 85 retrieves card identification information recorded on the recording unit 24 in association with other account information different from the received account information and the received terminal information.

Note that, more specifically, in a case where there is no card identification information associated with other account information different from the received account information and the received terminal information as a result of the retrieval, nothing needs to be uploaded. Thus, in such a case, the retrieval processing by the server 71 and the launch processing the client 11 both end.

In Step S53, the communication unit 83 transmits, to the client 11, the card identification i format regarding other account information obtained through the retrieval in Step S52 to be supplied from the control unit 85.

Then, in the client 11, in Step S14, the communication unit 25 receives the card identification information transmitted from the server 71 and supplies the card identification information to the device management unit 26.

That is, in Step S14, the card identification information transmitted from the server 71 in response to the transmission of the account information and the terminal information in Ste S13 is received.

In Step S15, the device management unit 26 retrieves, on the basis of the card identification information received in Step S14 to be supplied from the communication unit 25, service use information recorded on the contactless IC chip 23 in association with the card identification information.

In other words, the device management unit 26 confirms whether or not service use information regarding other users different from the logged-in user remains in the contactless IC chip 23.

In Step S16, the device management unit 26 determines whether or not there is service use information satisfying the retrieval conditions in Step S15. That is, it is determined whether or not, as a result of the retrieval, there is service use information recorded in association with the received card identification information.

In a case where it is determined in Step S16 that there is no such service use information, since no service use information needs to be uploaded, the processing in Step S17 to Step 9 is not performed, and the launch processing ends.

In contrast to this, in a case where it is determined in Step S16 that there is such service use information, the device management unit 26 instructs the display unit 22 to display an upload confirmation screen, and the processing proceeds to Step S17.

In Step S17, the display unit 22 displays the upload confirmation screen in response to the instruction from the device management unit 26 With this, the upload confirmation screen SC12 illustrated in FIG. 3, for example is displayed.

Further, when the user confirms the displayed upload confirmation screen and appropriately operates the input unit 21 to press the confirmation button, the processing in Step S18 is then performed.

That is, in Step S18, the device management unit 26 reads out, from the contactless IC chip 23, the service use information obtained as a result of the retrieval in Step S15, and supplies, to the communication unit 25, the read-out service use information and the card identification information associated with the service use information.

Here, after the read-out, the read-out service use information is no longer recorded on the contactless IC chip 23. That is, when being read out, the service use information is deleted from the contactless IC chip 23 by the device management unit 26. Note that, in this case, not only the service use information but also the card identification information may be deleted, or the user may specify whether to delete the card identification information or not.

In step S19, the communication unit 25 transmits, to the server 71, the card identification information and service use information supplied from the device management unit 26.

That is, the service use information is uploaded to the server 71, and a virtual card identified by the card identification information is thus deactivated.

It is assumed, for example, that the card identification information “444” and “666” illustrated in FIG. 6 is received from the server 71 in Step S14.

In this case, in Step S15, service use information associated with the card identification information “444” or “666” is retrieved from the contactless IC chip 23.

Further, it is assumed, for example, that as a result of the retrieval, there is no service use information associated with the card identification information. “444,” hut there is service use information associated with the card identification information “666.” Then, in Step S19, the card identification information. “666” and the service use information are uploaded to the server 71.

When the service use information is uploaded in this way, the device management unit 26 controls the display unit 22 so that the display unit 22 displays an upload completion screen. With this, the upload completion screen SC13 illustrated in FIG. 3, for example, is displayed on the display unit 22.

When the upload completion screen is displayed, the launch processing ends. When the launch processing ends, the display unit 22 then displays the menu screen SC14 illustrated in FIG. 3, for example, and the user can operate the menu screen SC14 to receive services.

Meanwhile, in the server 71, the processing in Step S54 is performed after the processing in Step S53 is performed.

That is, in Step S54, the control unit 85 determines whether or not service use information has been transmitted from the client 11.

In a case where it is determined in Step S54 that no service use information has been transmitted, the processing in Step S55 and Step S56 is not performed, and the retrieval processing ends.

In contrast to this, in a case where it is determined in Step S54 that service use information has been transmitted, in Step S55, the communication unit 83 receives the card identification information and service use information transmitted from the client 11, and supplies the card identification information and the service use information to the control unit 85. In Step S55, the card identification information and service use information transmitted in the processing in Step S19 is received.

In Step S56, the control unit 85 supplies, to the recording unit 84, the service use information received in Step S55 to be supplied from the communication unit 83, so that the recording unit 84 records the service use information. Then, the retrieval processing ends.

That is, for example, the control unit 85 updates card status management information recorded on the recording unit 84 in association with the received card identification information so that the card status management information includes the received service use information, with the result that the recording unit 84 records the service use information. With this, the service use information associated with the correct card identification information is recorded.

As described above, the client 11 transmits account information and terminal information to the server 71 at login. In case of receiving card identification information from the server 71 in response to the transmission the client 11 retrieves service use information recorded on the contactless IC chip 23 in association with the card identification information, and uploads the service use information to the server 71.

Further, when receiving account information and terminal information from the client 11, the server 71 retrieves card identification information regarding other account information, and transmits the card identification information to the client 11. When receiving service use information transmitted from the client 11, the server 71 records the service use information on the recording unit 84.

With this, even in a case where service use information regarding other users different from the user remains on the client 11, the risk of unauthorized use of the service use information can be easily reduced through the information transfer and retrieval processing with a small processing amount.

In particular, service use information regarding other users is retrieved to be uploaded to the server 71 immediately after a login is made so that the risk of unauthorized use can further be reduced.

In addition, there is no particular need for the user to issue an instruction on uploading information or the like and, when handing over the client 11 to another person, the user does not need to either use up service use information remaining on the client 11 or manually transfer the service use information to the server 71 or the like. Thus, according to the present technology, not only the risk unauthorized use of service use information can be easily reduced, but also the user-friendliness can be enhanced.

### <Configuration Example of Computer>

Incidentally, the series of processes described above can be executed by hardware or software. In the case where the series of processes is executed by software, a program configuring the software is installed on a computer. Here, examples of the computer include computers incorporated in dedicated hardware and general-purpose personal computers capable of executing various functions with various programs installed thereon.

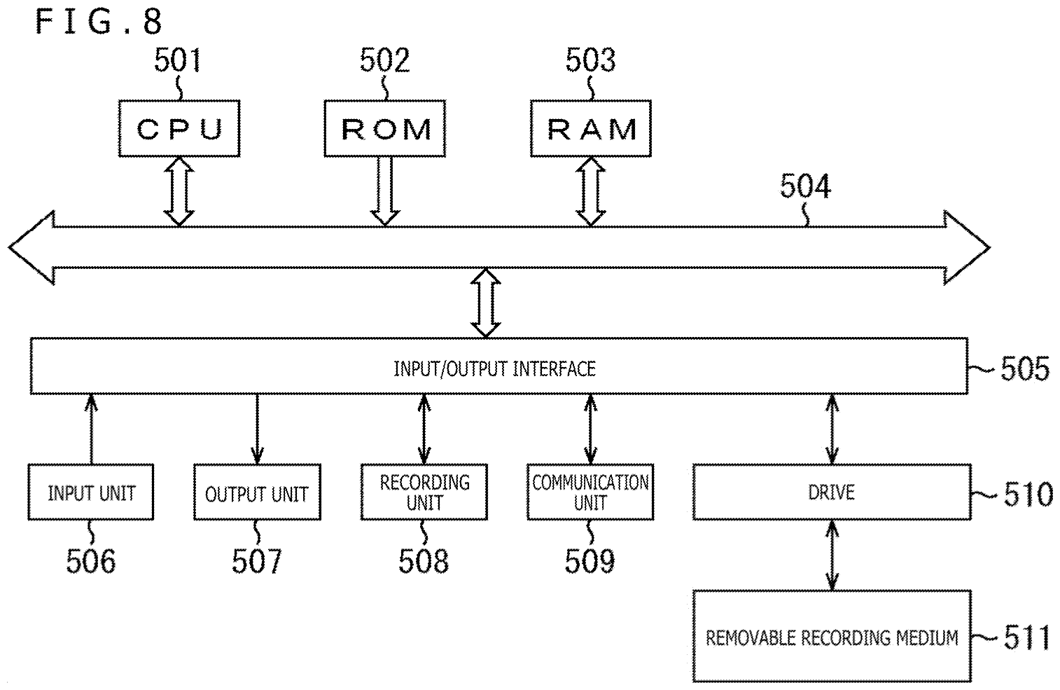

FIG. 8 is a block diagram illustrating a configuration example, of the hardware of a computer configured to execute the above-mentioned series of Processes with the program.

In the computer, a CPU (Central Processing Unit) 501, a ROM (Read Only Memory) 502, and a RAM (Random Access Memory) 503 are connected to each other by a bus 504.

An input/output interface 505 is further connected to the bus 504. To the input/output interface 505, an input unit 506, an output unit 507, a recording unit 508, a communication unit 509, and a drive 510 are connected.

The input unit 506 includes a keyboard, a mouse, a microphone, an imaging element, etc. The output unit 507 includes a display, a speaker, etc. The recording unit 508 includes a hard disk, a non-volatile memory, a contactless IC chip, etc. The communication unit 509 includes a network interface, etc. The drive 510 drives a removable recording medium 511 such as a magnetic disk, an optical disc, a magneto-optical disc, or a semiconductor memory.

In the computer configured as described above, for example, the CPU 501 loads the program recorded on the recording unit 508 into the RAM 503 through the input/output interface 505 and the bus 504 and executes the program to reform the series of processes described above.

The program that is executed by the computer (CPU 501) can be provided, for example, through e removable recording medium 511 having the program recorded thereon. The removable recording medium 511 is a package medium or the like. Further, the program can be provided through a wired or wireless transmission medium such as a local area network, the Internet, or digital satellite broadcasting.

In the computer, the program can be installed on the recording unit 508 through the input/output interface 505 with the removable recording medium 511 mounted on the drive 510. Further, the program can be received by the communication unit 509 through a wired or wireless transmission medium to be installed on the recording unit 508. Besides, the program can be installed on the ROM 502 or the recording unit 508 in advance.

Note that, with regard to the program that the computer executes, the processing of the program may be performed in chronological order in the order described herein or in parallel. Alternatively, the processing of the program may be performed at a right timing, for example, when the program is called.

Further, the embodiment of the present technology is not limited to the embodiment described above, and various modifications can be made without departing from the gist of the present technology.

For example, the present technology can employ the configuration of cloud computing that shares one function by a plurality of apparatuses via a network to process the function in cooperation.

Further, each step described in the above-mentioned flowchart can be executed by being shared by a plurality of apparatuses as well as being executed by one apparatus.

Moreover, in a case where a plurality of processes is included in one step, the plurality of processes included in the step can be executed by being shared by a plurality of apparatuses as well as being executed by one apparatus.

Moreover, the present technology can also take the following configurations.

(1)

An information processing apparatus, including:
a management unit configured to retrieve service use information that is used for using a service and recorded on a recording medium in association with card identification information regarding other account information different from predetermined account information, the card identification information identifying a card for using the service; and
a communication unit configured to upload the service use information obtained through the retrieval.
   (2)

The information processing apparatus according to (1),
in which, in a case where a login is made with the predetermined account information, the management unit retrieves the service use information, and
in which the communication unit uploads the service use information.
   (3)

The information processing apparatus according to (1) or (2),
in which the management unit retrieves the service use information recorded on the recording medium in association with the card identification information regarding the other account information received from a server, and
in which the communication unit uploads the service use information to the server.
   (4)

The information processing apparatus according to (3),
in which the communication unit transmits, to the server, the predetermined account information and terminal information identifying the information processing apparatus, and
in which the communication unit receives the card identification information regarding the other account information transmitted from the server in response the transmission of the predetermined account information and the terminal information.
   (5)

The information processing apparatus according to any one of (1) to (4), in which the service use information includes value information that is used for payment with the card.

(6)

The information processing apparatus according to (5), in which the value information includes balance information, remaining point information, or a credit card number.

(7)

The information processing apparatus according to any one of (1) to (6), in which the recording medium includes a contactless IC chip.

(8)

The information processing apparatus according to any one of (1) to (7), further including:
a display unit configured to display a confirmation screen indicating that the upload is to be performed or a completion screen indicating that the upload is complete.
   (9)

An information processing method, including:
causing an information processing apparatus to
   retrieve service use information that is used for using a service and recorded on a recording medium in association with card identification information regarding other account information different from predetermined account information, the card identification information identifying a card for using the service, and
   upload the service use information obtained through the retrieval.
      (10)

An information processing apparatus, including:
a recording unit configured to record account information identifying a user, terminal information identifying a terminal apparatus configured to function as a card for using a service, and card identification information identifying the card in association with each other;
a control unit configured to retrieve, in case receiving the account information and the terminal information from the terminal apparatus, the card identification information recorded on the recording unit in association with other account information different from the account information received and the terminal information received; and
a communication unit configured to transmit the card identification information obtained through the retrieval to the terminal apparatus.
   (11)

The information processing apparatus according to (10), in which, in a case where the control unit receives, from the terminal apparatus, the card identification information obtained through the retrieval and service use information that is used for using the service, the control unit controls the recording unit to record the service use information in association with the card identification information obtained through the retrieval.

(12)

The information processing apparatus according to (11), in which the service use information includes value information that is used for payment with the card.

(13)

The information processing apparatus according to (12),which the value information includes balance information, remaining point information, or a credit card number.

(14)

An information processing' method, including:
causing an information processing apparatus including a recording unit configured to record account information identifying a user, terminal information identifying a terminal apparatus configured to function as a card for using a service, and card identification information identifying the card in association with each other to
   retrieve, in case of receiving the account information and the terminal information from the terminal apparatus, the card identification information recorded on the recording unit in association with other account information different from the account information received and the terminal information received, and
   transmit the card identification information obtained through the retrieval to the terminal apparatus.

### REFERENCE SIGNS LIST

11 Client, 21 Input unit, 22 Display unit, 23 Contactless IC chip, 25 Communication unit, 26 Device management unit, 71 Server, 83 Communication unit, 84 Recording unit, 85 Control unit

1. An information processing apparatus, comprising:
a management unit configured to retrieve service use information that is used for using a service and recorded on a recording medium in association with card identification information regarding other account information different from predetermined account information, the card identification information identifying a card for using the service; and
a communication unit configured to upload the service use information obtained through the retrieval.

2. The information processing apparatus according to claim 1,
wherein, in a case where a login is made with the predetermined account information, the management unit retrieves the service use information, and wherein the communication unit uploads the service use information.

3. The information processing apparatus according to claim 1,
wherein the management unit retrieves the service use information recorded on the recording medium in association with the card identification information regarding the other account information received from a server, and
wherein the communication unit uploads the service use information to the server.

4. The information processing apparatus according to claim 3,
wherein the communication unit transmits, to the server, the predetermined account information and terminal information identifying the information processing apparatus, and
wherein the communication unit receives the card identification information regarding the other account information transmitted from the server in response to the transmission of the predetermined account information and the terminal information.

5. The information processing apparatus according to claim 1, wherein the service use information includes value information that is used for payment with the card.

6. The information processing apparatus according to claim 5, wherein the value information includes balance information, remaining point information, or a credit card number.

7. The information processing apparatus according to claim 1, wherein the recording medium includes a contactless IC chip.

8. The information processing apparatus according to claim 1, further comprising:
a display unit configured to display a confirmation screen indicating that the upload is to be performed or a completion screen indicating that the upload is complete.

9. An information processing method, comprising:
causing an information processing apparatus to
retrieve service use information that is used for using a service and recorded on a recording medium in association with card identification information regarding other account information different from predetermined account information, the card identification information identifying a card for using the service, and
upload the service use information obtained through the retrieval.

10. An information processing apparatus, comprising:
a recording unit configured to record account information identifying a user, terminal information identifying terminal apparatus configured to function as a card for using a service, and card identification information identifying the card in association with each other;
a control unit configured to retrieve, in case of receiving the account information and the terminal information from the terminal apparatus, the card identification information recorded on the recording unit in association with other account information different from the account information received and the terminal information received; and
a communication unit configured to transmit the card identification information obtained through the retrieval to the terminal apparatus.

11. The information processing apparatus according to claim 10, wherein, in a case where the control unit receives, from the terminal apparatus, the card identification information obtained through the retrieval and service use information that is used for using the service, the control unit controls the recording unit to record the service use information in association with the card identification information obtained through the retrieval.

12. The information processing apparatus according to claim 11, wherein the service use information includes value information that is used for payment with the card.

13. The information processing apparatus according to claim 12, wherein the value information includes balance information, remaining point information, or a credit card number.

14. An information processing method, comprising:
causing an information processing apparatus including a recording unit configured to record account information identifying a user, terminal information identifying a terminal apparatus configured to function as a card for using a service, and card identification information identifying the card in association with each other to
retrieve, case of receiving the account information and the terminal information from the terminal apparatus, the card identification information recorded on the recording unit in association with other account information different from the account information received and the terminal information received, and
transmit the card identification information obtained through the retrieval to the terminal apparatus.
